(19) United States
(12) Patent Application Publication
(10) Pub. No.: US 2016/0089766 A1
(43) Pub. Date: Mar. 31, 2016

(54) INDUCTION HARDENED PROCESSING SHAFT AND METHOD OF MAKING SAME

(71) Applicant: ENGINEERED ABRASIVES, INC., Alsip, IL (US)

(72) Inventor: Michael J. Wern, Alsip, IL (US)

(21) Appl. No.: 14/861,692

(22) Filed: Sep. 22, 2015

Related U.S. Application Data
(60) Provisional application No. 62/056,151, filed on Sep. 26, 2014.

(51) Int. Cl. B24C 3/20; C22C 38/00; C21D 1/42; F16C 3/02; C21D 9/00

(52) U.S. Cl. CPC B24C 3/20; F16C 3/02; C21D 9/0075; C21D 1/42; C22C 38/00

(57) ABSTRACT

An induction hardened processing shaft of a part-processing apparatus and method of manufacturing includes exposing a shaft to a partial induction hardening process. An induction hardening process may be applied to only the portion of the shaft that may be exposed to processing spray or shot peening material. The portion of the shaft exposed to induction hardening will include a harder surface material that can better withstand its composition and structure during impact, minimizing or reducing the amount of wear on the surface from exposure to processing material utilized in the part-processing apparatus. By limiting the induction hardening process to less than the full length of the shaft, the shaft is less likely to experience substantial deformation, and further permits screws and fasters to be driven into the shaft to secure the shaft at specific locations with the processing apparatus.

### CROSS REFERENCE TO RELATED APPLICATIONS

This application claims the benefit of priority under 35 U.S.C. §119(e) to U.S. Provisional Patent Application No. 62/056,151, filed Sep. 26, 2014. The disclosure set forth in the referenced application is incorporated herein by reference in its entirety.

### FIELD AND BACKGROUND

The subject matter disclosed herein relates to an improved component for a part processing apparatus and method of making same, and more particularly to a method of making a shaft for use in retaining parts being processed in an automatic part processing apparatus. More particularly, the present invention relates to an induction hardening shaft of a spindle or other rotational assembly. The part processing apparatus may be similar to the device as shown in U.S. Pat. No. 5,272,897, which is hereby incorporated by reference. In illustrative embodiments, the shaft may be similar to the shaft as shown in U.S. Application No. 61/927,071, filed Jan. 14, 2014, which is hereby incorporated by reference.

A shaft for a spindle assembly may be used in an automatic part processing apparatus for fully automated processing of a part by methods such as shot peening and the like. A processing apparatus as shown in U.S. Pat. No. 5,272,897 uses a shaft and spindle assembly to hold and rotate parts in the apparatus, the parts positioned on the upwardly extending shaft that is held in place by the spindle assembly coupled to the bottom of the processing apparatus. As the shaft is configured to rotate at continuous and high speeds, the shaft must be relatively straight in order to maintain the part located on the shaft is a fixed position as it rotates. As the parts rotate on the shaft, they are typically exposed to processing media.

Further, as the shaft is configured to hold up various types of parts, the shaft may be required to be somewhat thick to withstand the pressure of parts or other components without deforming the shaft. A part-hold down assembly may be configured to apply pressure to the parts to maintain them in a fixed position on the shaft while processing occurs. As a result of the weight of the parts and/or the downward pressure from the part-hold down assembly, fasteners, screws or other mechanisms may be attached to or incorporated in the shaft to attach the shaft to a fixed structure in order to prevent the shaft from unintended downward movement through the spindle assembly. For instance, when significant and/or repeated pressure is applied to the shaft to hold the part down during processing, the shaft may tend to slip and the fasteners, screw or other mechanism may prevent such slipping. The material and composition of the shaft must be such as to allow a screw to be driven into the shaft in order to secure the shaft is a specific position. As an alternative, the shaft may be blocked from unintended downward movement by a stepped shaft design, as disclosed in U.S. Application No. 61/927,071, which includes a radial step that abuts against a fixed structure of the spindle assembly to prevent downward movement. With one or more of these features, for example, the part is maintained at a specific height that is predetermined for processing the part, and the part does not slide out of alignment with the processing apparatus.

As the part is being processed, the shot peening or processing material may unintentionally contact an exposed portion of the shaft holding up the part being processed as well. During operation of the part processing apparatus, an unprocessed part is first placed on the shaft, and then processed, and finally the processed part is removed from the shaft. Another unprocessed part is then placed on the shaft again, and the process is repeated. As the shaft is secured to a turntable in the processing apparatus, it is a permanent fixture in the processing apparatus. As processing continues throughout many cycles of processing, the shafts are continuously blasted with shot peening or other processing material. Over time, the processing material can wear away at the exposed portions of the shaft that are unintentionally sprayed with the processing material, reducing the diameter of the shaft and shortening the useful lifespan of the shaft. Given the specific dimension and strain requirements for a shaft, it may be very difficult to recondition a worn out or used shaft for additional usage. Further, given the positioning of the shaft in a permanent position in the processing apparatus, it is disadvantageous to frequently replace the shaft.

This background information is provided to provide some information believed by the applicant to be of possible relevance to the present disclosure. No admission is intended, nor should such admission be inferred or construed, that any of the preceding information constitutes prior art against the present disclosure. Other aims, objects, advantages and features of the disclosure will become more apparent upon reading of the following non-restrictive description of specific embodiments thereof, given by way of example only with reference to the accompanying drawings.

### SUMMARY

It is desirable for a shaft to be hard enough to withstand being continuously exposed to the peening or processing material without being worn away, but at the same time ensure the shaft is both straight and malleable enough to permit items such as screws and fasteners to be secured to the shaft at certain locations to maintain the shaft at the proper height.

Various induction hardening techniques may be used to harden a work piece. In various applications, induction hardening may be considered a two-step process. First, a non-contact heat treatment process is applied to a surface of a work piece. A current may be generated and applied to the surface of a work piece in order to cause the temperature of the surface to increase. Second, once the surface of the work piece reaches a certain temperature to cause various properties of the material of the work piece to change, the work piece may be quickly cooled or quenched in order to create a harder surface material than the original work piece material.

Application of a traditional induction hardening technique applied to a shaft of a processing apparatus may create drawbacks. In general, induction hardening of a work piece is known to produce substantial deformation in the work piece, to the point where sometimes the work piece must be further processed or straightened prior to use. Further, induction hardening, by definition, hardens the work piece and prevents or interferes with the ability to engage or insert various components, such as screws, bolts or other fasteners, into or against the surface of the work piece. In particular, a fastener may not engage or tighten properly with a very hard piece of metal because it does not receive the same frictional traction or scoring into a harder piece of material as opposed to a softer piece of material.

In illustrative embodiments, a partial induction hardening process may be applied to a shaft of a processing apparatus. Specifically, an induction hardening process may be applied to only the portion of the shaft that may be exposed to processing spray or shot peening material. The portion of the shaft exposed to induction hardening will include a harder surface material that can better withstand its composition and structure during impact, minimizing or reducing the amount of wear on the surface from exposure to the peening material. By limiting the induction hardening process to less than the full length of the shaft, the shaft is less likely to experience substantial deformation, and further permits screws and fasters to be driven into the shaft to secure the shaft at specific locations with the processing apparatus.

These and other advantages and features will become more apparent from the following description taken in conjunction with the drawings.

### BRIEF DESCRIPTION OF THE DRAWINGS

The present disclosure will be described hereafter with reference to the attached drawings which are given as a non-limiting example only, in which:

FIG. 1 is a front perspective view of an automatic part processing apparatus of a part by a method such as peening, with a portion broken away to reveal a turntable to which lower spindle assemblies are located, the lower spindle assemblies including rotating shafts that extend upward into a processing field above the turn-table to hold the part being processed;

FIG. 2 is a partial cross-sectional view of a portion of the spindle assembly of FIG. 1 above the turntable, showing by way of illustrative and not limitation a part hold-down assembly of the spindle assembly that is applying downward pressure to the part being processed on the rotating shaft, and further showing that the shaft extends from the spindle assembly to retain the part on a support portion of the shaft;

FIG. 3A is a side view of the shaft of the spindle assembly of FIG. 1, showing the shaft includes a top portion that is configured to extend into the processing field above the turntable and further includes a bottom portion that is configured to be retained outside of the processing field below the turntable;

FIG. 3B is a cross-sectional view of a portion of the spindle assembly of FIG. 1, showing the shaft extends above and below the turntable, showing the shaft is configured to extend through an aperture of the turntable and through one or more bearing housings and/or a pulley of the spindle assembly, the shaft being secured to the bearing housing via screws or other fasteners that extend into the shaft from the bearing housings and/or pulley at a position on the shaft under the turntable;

FIG. 4 is a side perspective view of the automatic part processing apparatus showing the part retained on the shaft in a specific position relative to a processing nozzle, and further showing an exposed portion of the shaft in the processing field being in the spray area of the processing nozzle below the part;

FIG. 5A is diagrammatic view of the shaft of FIG. 1 undergoing an illustrative example of a partial induction hardening process; and

FIG. 5B is a cross-sectional view of the shaft of FIG. 5A after it has undergone the partial induction hardening process of FIG. 5A, illustrating the hardened surface of the shaft along a portion of the shaft.

The exemplification set out herein illustrates embodiments of the disclosure that are not to be construed as limiting the scope of the disclosure in any manner. Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure. The disclosure is not limited in its application to the details of structure, function, construction, or the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of various phrases and terms is meant to encompass the items or functions identified and equivalents thereof as well as additional items or functions. Unless limited otherwise, various phrases, terms, and variations thereof herein are used broadly and encompass all variations of such phrases and terms. Furthermore, and as described in subsequent paragraphs, the specific configurations illustrated in the drawings are intended to exemplify embodiments of the disclosure. However, other alternative structures, functions, and configurations are possible which are considered to be within the teachings of the present disclosure. Furthermore, unless otherwise indicated, the term “or” is to be considered inclusive.

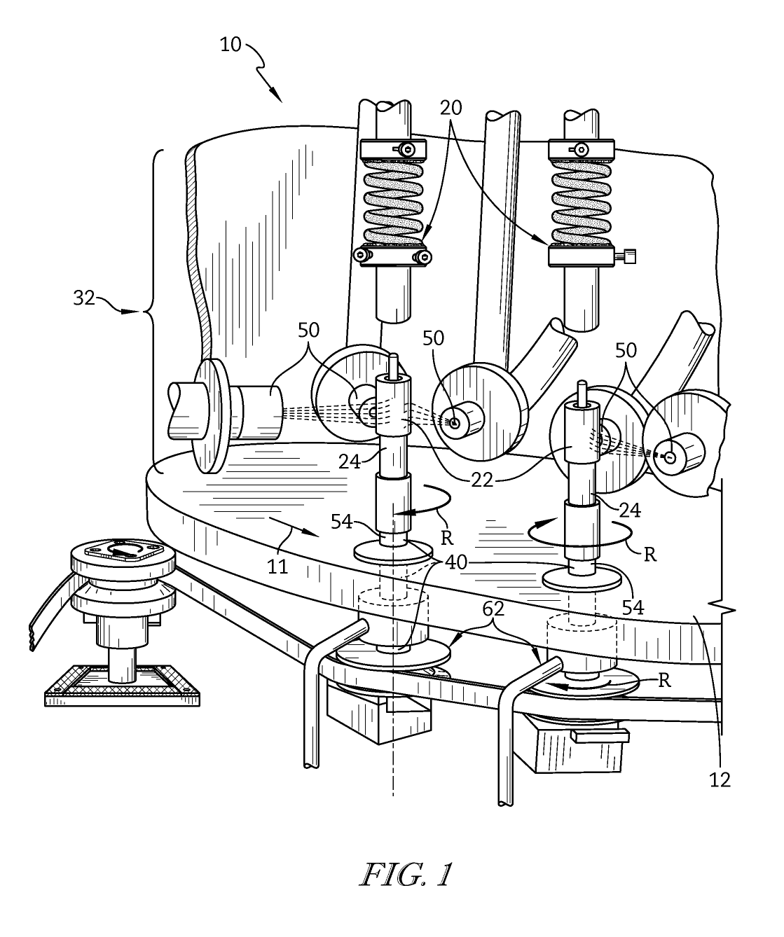

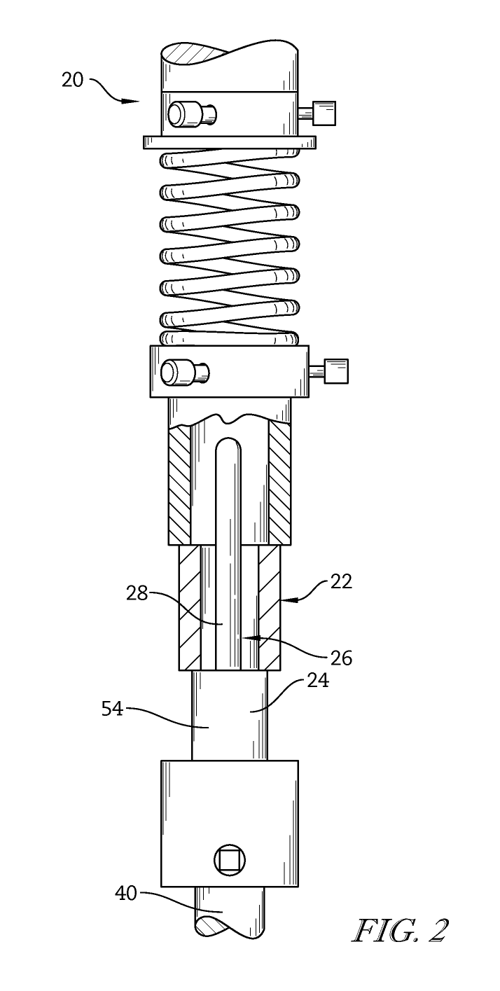

As shown in FIG. 1, a processing assembly 10 of a larger parts-processing apparatus is shown. The overall parts processing apparatus is similar to that as shown and described in U.S. Pat. No. 5,272,897, incorporated by reference herein. While the basic operation of this parts processing assembly 10 will be described herein, the primary focus of the present application will be on the structures and functions associated with a spindle assembly 62 that supports a part being processed in the processing assembly 10.

In illustrative embodiments, the spindle assembly 62 is configured to be permit rotational movement of a part retained on the spindle assembly 62 as it is processed in the processing assembly 10. In various embodiments, the spindle assembly 62 includes at least a shaft 40 to retain the part in a predetermined position as the part is being processed. During use of the processing assembly 10, a part 22 can be fixtured on a support portion 24 of the shaft 40, as illustrated in FIG. 1. In order to rotate the part 22 during processing, the spindle assembly 62 rotates the shaft 40, and in particular the support portion 24. The part 22 may be of varying forms, but may typically be a hollow component, at least for the present configuration of the apparatus, having a generally cylindrical cavity 26 extending therethrough. An example of such a part 22 might include an automotive gear component. A pin 28 may extend from the support portion 24 through the cavity 26 of the part 22 to help provide axial alignment of the components within the processing assembly 10.

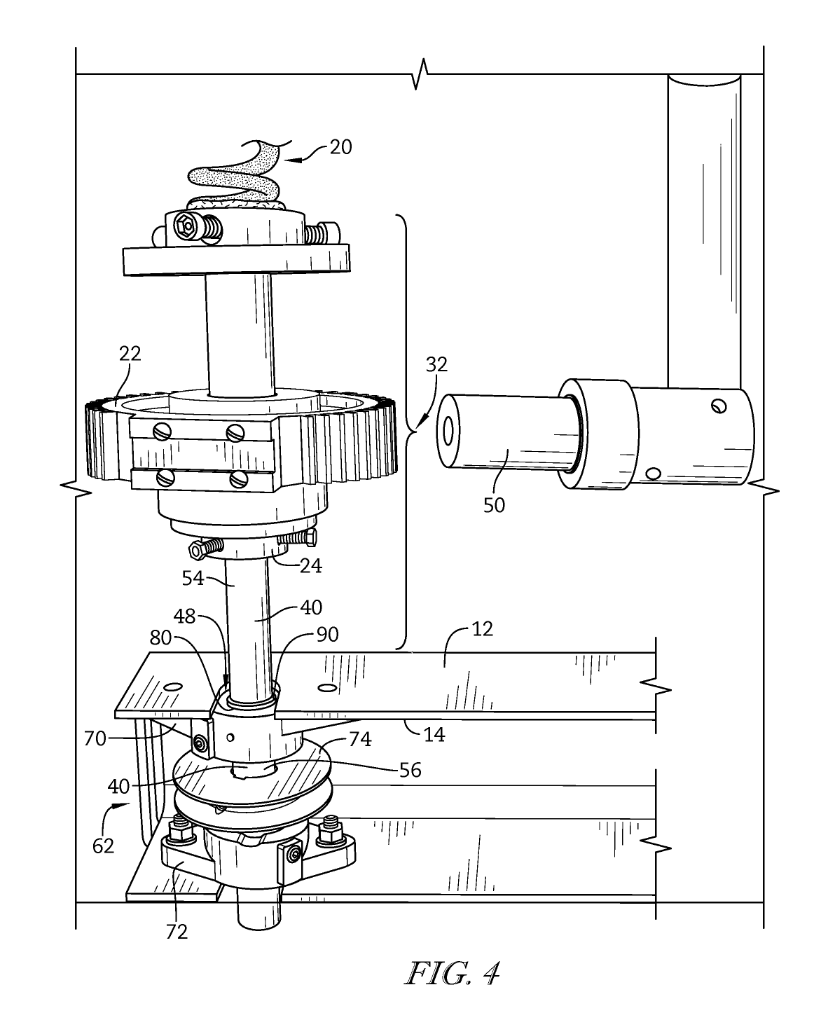

While not described herein, reference is made to the incorporated patent, U.S. Pat. No. 5,272,897, with regard to the operation of the overall part processing apparatus. The processing assembly 10 receives a part 22 mounted on the support portion 24 of the shaft 40, which is then processed in an automated manner. The processing may include automated fixturing of a part hold-down assembly 20 against the part 22, rotation of the part 22 relative to processing nozzles 50 via rotation of the shaft 40, and movement of the part 22 on a turntable 12 through a processing path 11. For example, one type of process used with such processing assembly 10 may be peening. As shown in FIG. 1, a series of peening nozzles 50 may be directed in a predetermined vicinity and direction of the parts 22 carried on the support portion 24 of the shaft 40. While the process itself is not the subject of the present application, the operation of the process is important because it highlights the fact that peening material is introduced and sprayed in a processing field 32 that surrounds the area where the part 22 is being processed. The processing field 32 may be defined at a lower boundary by the top of the turntable 12, as illustrated n FIGS. 1 and 4, as the turntable 12 may block or prevent peening material from exiting the processing field 32.

When mounted on the support portion 24, the part 22 is processed in the processing assembly 10 by movement of the part 22 along the processing path 11, as shown in FIG. 1. The turntable 12 permits the part 22 to travel along the processing path 11 through the processing assembly 10. Specifically, the processing assembly 10 is configured to carry the part 22 around the processing assembly 10 by rotation of the turntable 12. Accordingly, a portion of the shaft 40 necessarily extends into the processing field 32. Consequently, by spraying the part 22 with peening or other processing material, a portion of the shaft 40, such as external circumferential surface 64 of the shaft 40, and in particular the support portion 24, is unintentionally sprayed with such material, as well. The support portion 24 of the shaft 40 holding the part 22 is further connected to one or more spindle assemblies 62 attached to the turntable 12 below the turntable 12, as illustrated in FIGS. 1 and 4. Accordingly, a portion of the surface of the shaft 40 extends outside of the processing field 32 and is blocked from substantial exposure to processing material spray.

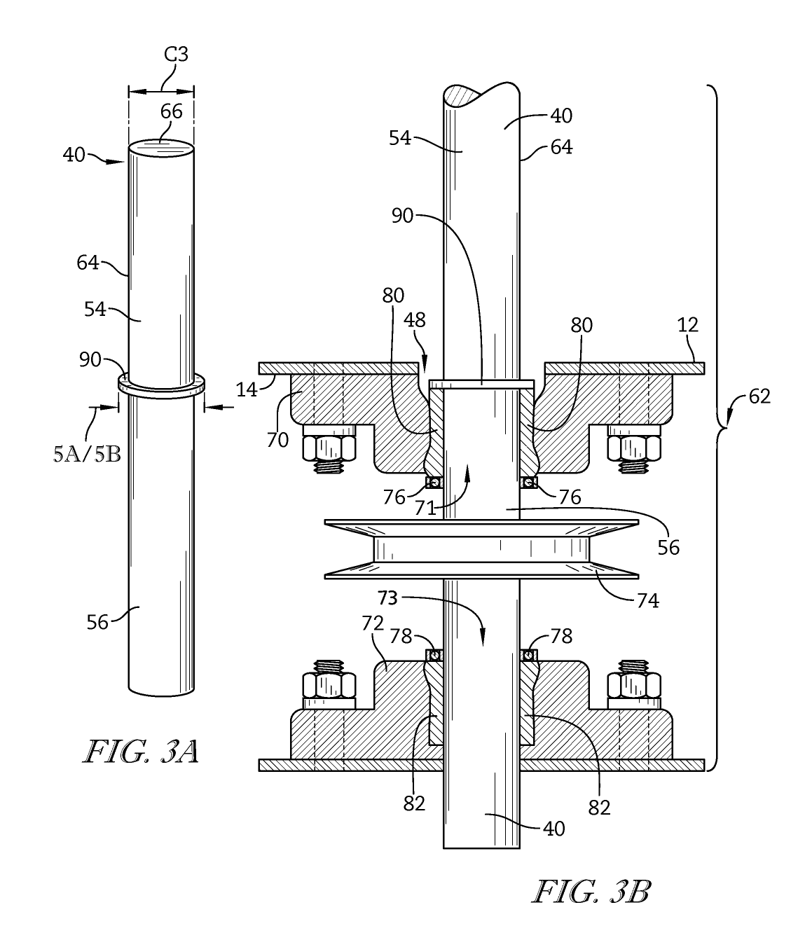

In illustrative embodiments, in addition to the turntable 12 being rotatable to carry the part 22 around the processing assembly 10, the shaft 40 is also rotatable relative to the turntable 12 in order to rotate the part 22 with respect to an individual nozzle 50, as illustrated by arrow R in FIG. 1. More specifically, the shaft 40 of the processing assembly 10 is configured to extend through an aperture 48 in the turntable 12 and is rotatable with respect to the turntable 12 via the spindle assembly 62 that attaches the shaft 40 to a bottom surface 14 of the turntable 12, as illustrated in FIG. 3. In this manner, the full circumference of the external surface 64 shaft 40 that is within the processing field 32 may be unintentionally sprayed with peening material from a nozzle 50 as a part 22 is being processed. A portion of the spindle assembly 62 is fixedly attached to the bottom surface 14 of the turntable 12 to secure the spindle assembly 62 and shaft 40 with respect to the turntable 12. In various embodiments, a portion of the shaft 40 may be required to be fixedly attached to the spindle assembly 62 via fasteners or screws that are configured to screw into and past the surface of the shaft 40, as described in more detail below.

In this way, the part 22, and the shaft 40 on which it rests, moves with the turning of the turntable 12 and travels around the processing assembly 10 to be exposed to multiple processing operations along the processing path 11. In addition, the part 22 and shaft 40 are also movable in a rotational direction R during processing at each of the processing operations, the part being rotatable on the shaft 40 via the spindle assembly 62 which is fixedly secured to the turntable 12.

As shown in FIG. 3, in illustrative embodiments the shaft 40 is configured to be secured to the spindle assembly 62 in order to ensure the shaft 40 does not slip downward by any variety of known means. For example, the shaft 40 may be secured in an upper bearing 70 of the spindle assembly 62 by a pair of fasteners or set screws 76 extending through a race portion 80 of the upper bearing 70 and into an aperture 71 to abut against and/or insert into the surface of the shaft 40. Similarly, the shaft 40 may be secured to a lower bearing 72 of the spindle assembly 62 by a pair of fasteners or set screws 78 extending through a race portion 82 of the lower bearing 72 and into an aperture 73 to abut against and extend into the surface 64 of the shaft 40. The shaft 40 may be secured to the pulley assembly 74 by similar means. In illustrative embodiments, to facilitate maintenance and replacement of the spindle assembly 62 components and the shaft 40, the fasteners or set screws 76, 78 may not be configured to extend through the shaft 40, but merely screw partially into the outer surface 64 of the shaft 40 to create frictional engagement to hold the shaft 40 in fixed placement with respect to the rest of the spindle assembly 62 components. In other illustrative embodiments, a step 90 may be located around the outer surface 64 of the shaft to abut against the race portion 80 of the upper bearing 70, further preventing the shaft 40 from slipping downward.

In illustrative embodiments, the support portion 24 on which the part 22 is supported, or the shaft 40 itself, may be exposed to the peening material being sprayed at the part 22 from the nozzle 50 in the processing field 32, as illustrated in FIG. 4. Specifically, an exposed portion 54 of the shaft 40 in the processing field 32 may be repeatedly subjected to a peening process as various parts are processed in processing assembly 10. Conversely, a bottom portion 56 of the shaft 40 below the processing field 32 may be located adjacent to the spindle assembly 62 through which the shaft 40 rotates such that the fasteners or set screws 76, 78 extend through the surface 64 of the shaft 40 at the bottom portion 56.

In order to reduce the amount of wear and tear on the shaft 40 from peening adjacent to the part 22, while still permitting proper engagement of the fasteners or set screws 76, 78 with the shaft 40, an induction hardening technique 30 is proposed whereby the shaft 40 is only partially hardened at or near the exposed portion 54 of the shaft, while the bottom portion 56 is not exposed to induction hardening. In illustrative embodiments, the induction hardening technique 30 may be applied along a length L of the shaft 40 that is less than the full length of the shaft 40. For example, the induction hardening technique 30 may be applied only in the areas of the exposed portion 54, or it may be applied to extend from the exposed portion 54 to the top end 66 of the shaft 40, before it is received within the processing assembly 10.

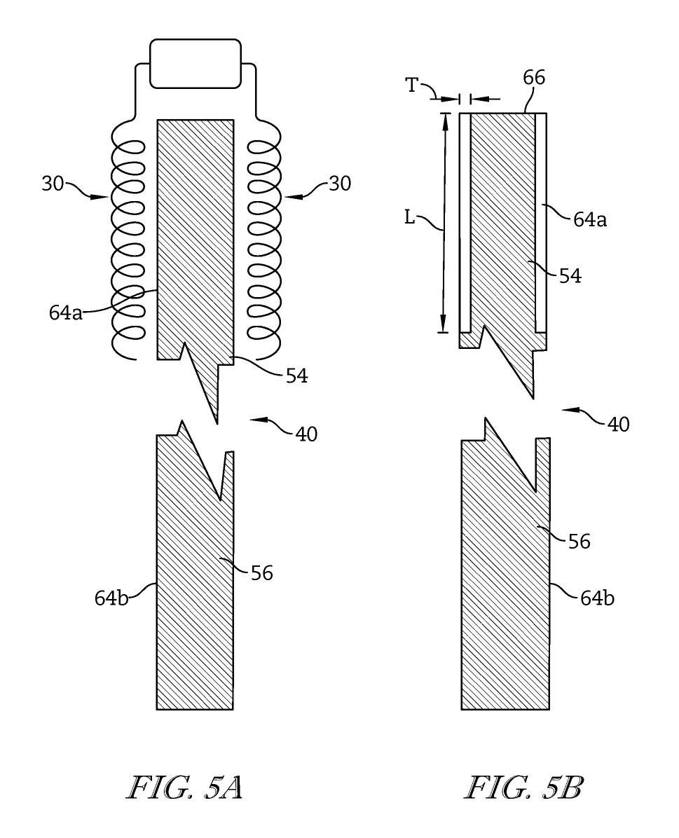

In an illustrative embodiment, as illustrated in FIGS. 5A and 5B, the shaft 40 may be treated to an induction hardened technique 30 whereby a non-contact heat treatment process is applied to the length L between the exposed portion 54 and the top end 66 of the shaft 40, leaving the bottom portion 56 of the shaft 40 to remain substantially the same temperature during the induction hardening technique 30. The length L may be defined by the surface 64a exposed to the induction hardening technique 30 (e.g. the exposed portion 54 of the shaft 40). The surface 64a is substantially hardened through the induction process, while a surface 64b that is not exposed to the induction hardening technique 30 remains substantially the same. In illustrative embodiments, the surface 64b may be located along the bottom portion 56 of the shaft 40. The bottom portion 56 of the shaft 40 may be configured to be located outside the processing field 32. The surface 64b is thereby unhardened and permits fasteners or set screws 76, 78 to properly engage with the surface 64b of the bottom portion 56 of the shaft 40. Moreover, as the bottom portion 56 of the shaft 40 is not subject to the induction hardening technique 30, it will not warp or become deformed, thereby reducing any reprocessing or straightening of the bottom portion 56 of the shaft 40 prior to use.

Various forms of an induction hardening technique 30 are known in the industry. The present disclosure is not limited in any way to a specific method or process of induction hardening.

In illustrative embodiments, the shaft 40 may be made of various materials to promote hardening of surface 64a from the induction hardening technique 30 while still permitting fasteners or set screws 76, 78 to engage with surface 64b. In illustrative embodiments, such material may include 4140 alloy steel.

In illustrative embodiments, the thickness T of the hardened material (e.g. case depth) on the surface 64a of the exposed portion 54 of the shaft 40 may be determined based on the desired wear and tear the shaft 40 may be exposed to. In various embodiments, the thickness T may be 1/16 inch or more around the circumferential surface 64a of the exposed portion 54. The thickness T may alternatively be a few thousands of an inch. Other dimensions for thickness T are also envisioned and may be dependent on the specific diameter C3 of the shaft 40.

The foregoing terms as well as other terms should be broadly interpreted throughout this application to include all known as well as all hereafter discovered versions, equivalents, variations and other forms of the abovementioned terms as well as other terms. The present disclosure is intended to be broadly interpreted and not limited.

While the present disclosure describes various exemplary embodiments, the disclosure is not so limited. To the contrary, the disclosure is intended to cover various modifications, uses, adaptations, and equivalent arrangements based on the principles disclosed. Further, this disclosure is intended to cover such departures from the present disclosure as come within at least the known or customary practice within the art to which it pertains. It is envisioned that those skilled in the art may devise various modifications and equivalent structures and functions without departing from the spirit and scope of the disclosure.

I claim:

1. A part processing assembly comprising a support shaft configured to support a part within the processing assembly, the support shaft including a first section extending into a processing field of the processing assembly and a second section extending outside of the processing field, wherein, before installation in the processing assembly, at least a portion of the first section is subjected to an induction hardening technique and the second section is not subjected to an induction hardening technique.

2. The part processing assembly of claim 1, wherein the support shaft is configured to rotate a part within the processing assembly.

3. The part processing assembly of claim 2, wherein the support shaft is coupled to a spindle assembly, the spindle assembly located outside of the processing field.

4. The part processing assembly of claim 3, wherein the support shaft is coupled to the spindle assembly through screws or fasteners inserted into the support shaft.

5. The part processing assembly of claim 3, wherein the spindle assembly rotates the support shaft as parts are being processed in the processing assembly.

6. The part processing assembly of claim 3, wherein a turntable of the processing assembly defines a lower boundary of the processing field.

7. The part processing assembly of claim 2, wherein the support shaft includes a step that abuts against a turntable of the processing assembly to retain the support shaft in a fixed position.

8. The part processing assembly of claim 7, wherein the step defines the boundary between the first second and the second section of the support shaft.

9. The part processing assembly of claim 1, wherein an exposed surface of the support shaft and the part supported by the support shaft are exposed to peening media within the processing field.

10. The part processing assembly of claim 9, wherein the first section of the support shaft includes the exposed surface of the support shaft.

11. The part processing assembly of claim 10, wherein the first section of the support shaft extends from the exposed surface of the support shaft to a top edge of the support shaft.

12. The part processing assembly of claim 2, wherein the processing assembly further includes a turntable that moves the rotating support shaft along a processing path in the processing assembly.

13. The part processing assembly of claim 12, wherein the processing path is circular.

14. A method of manufacturing a part processing apparatus, the method comprising:
forming a shaft that can support a part within a processing field of the apparatus, the processing field defined by the area exposed to media during part processing;
applying an induction hardening technique to a first section of the shaft while avoiding application of the induction hardening technique to a second section of the shaft;
utilizing the shaft within the apparatus such that the first section of the shaft is located within the processing field and the second section of the shaft is located outside of the processing field; and securing the shaft to a fixed location outside of the processing field along the second section of the shaft.

15. The method of claim 14, further including securing a part hold-down apparatus inside the processing field that is vertically aligned with the shaft.

16. The method of claim 15, wherein the part hold-down apparatus applies a downward pressure to a part support by the shaft.

17. The method of claim 14, wherein the part processing apparatus further includes one or more spray nozzles configured to spray media into the processing field.

18. The method of claim 14, wherein the shaft further includes a support portion to support the part.

19. The method of claim 14, wherein the shaft further includes a pin configured to extend through a cavity of a part.

20. The method of claim 14, wherein the apparatus further includes means for rotating the shaft and the part supported by the shaft within the apparatus.
